(19) United States
(12) Patent Application Publication
(10) Pub. No.: US 2012/0196205 A1
(43) Pub. Date: Aug. 2, 2012

(54) ELECTRODE FOR FUEL CELL, MEMBRANE ELECTRODE ASSEMBLY AND FUEL CELL

(75) Inventors: Jung-ock PARK, Yongin-si (KR); Tae-young Kim, Seoul (KR); Seong-woo Choi, Yongin-si (KR); Yoon-hoi Lee, Hwaseong-si (KR)

(73) Assignee: Samsung Electronics Co., Ltd., Suwon-si (KR)

(21) Appl. No.: 13/356,196

(22) Filed: Jan. 23, 2012

(30) Foreign Application Priority Data
Feb. 1, 2011 (KR) 10-2011-0010297
Aug. 19, 2011 (KR) 10-2011-0083050

(51) Int. Cl. H01M 8/10; H01M 4/86; H01M 4/90

(52) U.S. Cl. 429/480; 429/529; 429/524; 429/525; 429/526; 429/527

(57) ABSTRACT

An electrode for a fuel cell, a membrane electrode assembly including the electrode, and a fuel cell including the membrane electrode assembly. Due to the inclusion of a barrier layer between a diffusion layer and a catalyst layer, the electrode prevents leakage of phosphoric acid moving from the catalyst layer to the diffusion layer and prolongs the lifetime of the membrane electrode assembly.

### CROSS-REFERENCE TO RELATED APPLICATIONS

This application claims the benefit of Korean Patent Application No. 10-2011-0010297, filed on Feb. 1, 2011, and Korean Patent Application No. 10-2011-0083050, filed on Aug. 19, 2011, in the Korean Intellectual Property Office, the disclosures of which are incorporated herein in their entirety by reference.

### BACKGROUND OF THE INVENTION

1. Field of the Invention

Aspects of the present disclosure relate to electrodes for a fuel cell, membrane electrode assemblies including the electrodes, and fuel cells including the membrane electrode assemblies.

2. Description of the Related Art

Fuel cells, which are an attractive source of alternative energy, can be categorized into polymer electrolyte membrane fuel cells (PEMFCs), direct methanol fuel cells (DMFCs), phosphoric acid fuel cells (PAFCs), molten carbonate fuel cells (MCFCs), and solid oxide fuel cells (SOFCs) according to the type of electrolyte and fuel used therein.

Among the polymer electrolyte membrane fuel cells (PEMFCs), a PEMFC that operates at a high temperature of 100° C. or higher (for example, 150-180° C.) under non-humidified conditions does not use a humidifier, water contained in the PEMFC is present in a vapor state, and thus, compared to a PEMFC that operates at a low temperature, water may be easily discharged therefrom. Thus, a PEMFC that operates at a high temperature under non-humidified conditions is known for its ease of water management and for providing a highly reliable system.

Currently, with regard to a membrane-electrode assembly (MEA) for a high temperature and non-humidified PEMFC, an acid doping MEA is commercially available and a non-acid doping MEA is not commercially available. Therefore, research into a non-acid doping MEA is being performed.

In a PEMFC including a phosphoric acid doping MEA, phosphoric acid that has entered an electrode from an electrolyte membrane functions as a major hydrogen ion conductor in the electrode. When the fuel cell operates, the distribution and amount of phosphoric acid in the electrode may continuously change according to operating conditions. For example, water generated at an air electrode contributes to a change in a phosphoric acid concentration. When the amount and distribution of phosphoric acid in the electrode are changed, the catalyst use rate is changed, thereby affecting the performance of the fuel cell. Also, water generated during repeated stop and start operations of the fuel cell freezes at low temperature, which reduces the phosphoric acid concentration, and thus, phosphoric acid leakage occurs. When the phosphoric acid leakage is too high during operation of the fuel cell, film resistance increases and catalyst/conductor contact area decreases, and thus, reactivity of a catalyst layer decreases. Although the phosphoric acid leakage is controllable to a certain level by the water repellent property of the diffusion layer, theflow of the phosphoric acid from the catalyst layer to the diffusion layer due to a capillary phenomenon may not be preventable. Thus, the performance of the fuel cell decreases and the lifetime characteristic thereof also deteriorates.

### SUMMARY OF THE INVENTION

Aspects of the present invention provide electrodes for a fuel cell that has reduced leakage of phosphoric acid during operation thereof.

Aspects of the present invention provide membrane electrode assemblies including the electrodes.

Aspects of the present invention provide fuel cells including the membrane electrode assemblies.

According to an aspect of the present invention, an electrode for a fuel cell includes a diffusion layer including a support and a microporous layer disposed on the support; a catalyst layer disposed facing the microporous layer; and a barrier layer disposed between the catalyst layer and the microporous layer, wherein the average pore size of the barrier layer may be greater than the average pore size of the catalyst layer and the average pore size of the microporous layer.

The maximum size of pores of the barrier layer may be 50 μm or less.

The minimum size of pores of the barrier layer may be 1 nm or more.

The average pore size of the barrier layer may be 25 μm or less.

The average pore size of the barrier layer may be 10 μm or less.

The average pore size of the barrier layer may be, for example, in the range of about 200 nm to about 5 μm.

The barrier layer may include at least one conductive material selected from the group consisting of a carbonaceous material, a metallic material, a polymeric material, and a ceramic material. The carbonaceous material may include at least one material selected from the group consisting of carbon powder, carbon black, acetylene black, activated carbon, carbon fiber, fullerene, carbon nano-tube, carbon nano-wire, carbon nano-horn, and carbon nano-ring.

The barrier layer may include a particulate matter. The diameter of the particles in the particulate matter may be in the range of about 0.1 to about 50 μm.

The barrier layer may include at least one metal porous structure selected from the group consisting of metal mesh and foam metal.

The barrier layer may further include a water repellent material. The water repellent material may include at least one polymer selected from the group consisting of polytetrafluoroethylene (PTFE), fluorinated ethylene propylene (FEP), polyvinylidenefluoride (PVdF), perfluoroalkoxy (PFA), a 2,2-bistrifluoromethyl-4,5-difluoro-1,3-dioxole tetrafluoroethylene copolymer, and a sulfonated tetrafluoroethylene-based fluoropolymer-copolymer.

The barrier layer may further include a catalytic metal supported on the barrier layer. The catalytic metal may be selected from the group consisting of platinum (Pt), iron (Fe), cobalt (Co), nickel (Ni), ruthenium (Ru), rhodium (Rh), palladium (Pd), osmium (Os), iridium (Ir), copper (Cu), silver (Ag), gold (Au), tin (Sn), titanium (Ti), chromium (Cr), a mixture thereof, and an alloy thereof.

The barrier layer has a multi-layered structure in which a plurality of porous matrices may be stacked. The stacked porous matrices have different average pore sizes.

The thickness of the barrier layer may be in a range of about 5 to about 50 μm.

The barrier layer suppresses leakage of inorganic acid or organic acid from the catalyst layer to the diffusion layer.

According to another aspect of the present invention, a membrane electrode assembly for a fuel cell includes a cathode; an anode facing the cathode; and a polymer electrolyte membrane disposed between the cathode and the anode, wherein at least one of the cathode and the anode may include the electrode.

According to an aspect of the present invention, a fuel cell includes the membrane electrode assembly.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 is a schematic cross-sectional view of an electrode for a fuel cell according to an embodiment of the present invention;

FIG. 2 is an enlarged cross-sectional view of the electrode of FIG. 1, illustrating how leakage of phosphoric acid toward a diffusion layer is suppressed;

FIG. 3 is a schematic exploded perspective view of an electrode for a fuel cell, according to another embodiment of the present invention;

FIG. 4 is a schematic exploded perspective view of an electrode for a fuel cell, according to another embodiment of the present invention;

FIG. 5 shows cumulative pore volume distribution results of a support, a microporous layer (MPL), a catalyst layer, a barrier layer, and a catalytic metal-supported barrier layer included in a fuel cell manufactured according to Examples 1-4 and Comparative Examples 1 and 2;

FIG. 6 is a bar graph of the relative amounts of phosphoric acid measured after preservation of unit cells at a temperature of 80° C. for 3 weeks in fuel cells manufactured according to Comparative Example 1 and Example 1;

FIG. 7 is a graph of a voltage with respect to a daily stop start (DSS) operation of the fuel cells manufactured according to Comparative Example 2 and Examples 2 to 4; and

FIG. 8 is a bar graph of relative amounts of phosphoric acid remaining in membrane-electrode assemblies (MEAs) in fuel cells manufactured according to Comparative Example 2 and Example 2 after the DSS operation was performed.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below to explain the present invention by referring to the figures.

An electrode for a fuel cell according to an embodiment of the present invention includes a diffusion layer including a support and a microporous layer disposed on the support; a catalyst layer disposed facing the microporous layer; and a barrier layer disposed between the catalyst layer and the microporous layer, wherein the average pore size of the barrier layer is greater than the average pore size of the catalyst layer and the average pore size of the microporous layer.

The term “average pore size” used herein refers to the pore size corresponding to 50% of the whole cumulative curve of pore distribution set as 100%, that is, the pore size (hereinafter referred to as “D₅₀”) at a point where the volume accounts for 50% in the pore distribution curve formed by cumulating volumes from smaller pore sizes to larger pore sizes.

The average pore size may be measured using various known methods. For example, the cumulative curve of the pore size distribution is obtained using optical microscopy or electron microscopy, X-ray scattering, gas adsorption, mercury intrusion, liquid extrusion, a molecular weight cut off method, a fluid displacement method, or pulse NMR, and the average pore size D₅₀ may be a value corresponding to a point where the cumulative frequency of the volume distribution is 50%.

Typically, in a polymer electrolyte membrane fuel cell using a phosphoric acid-doping electrolyte membrane, phosphoric acid that has entered an electrode from the electrolyte membrane functions as a hydrogen ion conductor in the electrode. However, when an operation of the fuel cell is repeatedly stopped and started, the phosphoric acid may leak a lot. When leakage of phosphoric acid is too high during the operation of the fuel cell, the film resistance may increase and the catalyst/conductor contact area reduces, and thus, the reactivity of the catalyst layer decreases. Also, the phosphoric acid that excessively leaks into the diffusion layer may clog pores of the diffusion layer, thereby preventing fuel supply to the catalyst layer. This situation is referred to as flooding.

However, the electrode according to an embodiment of the present invention may prevent leakage of phosphoric acid from the catalyst layer to the diffusion layer by forming the barrier layer between the catalyst layer. and the diffusion layer. The electrode includes the barrier layer having an average pore size that is greater than those of the catalyst layer and the diffusion layer, and when the phosphoric acid flows from the catalyst layer to the diffusion layer, due to the a sudden decrease in a capillary force in the barrier layer, the phosphoric acid cannot pass through the barrier layer. Thus, the amount of phosphoric acid flowing toward the diffusion layer may be reduced.

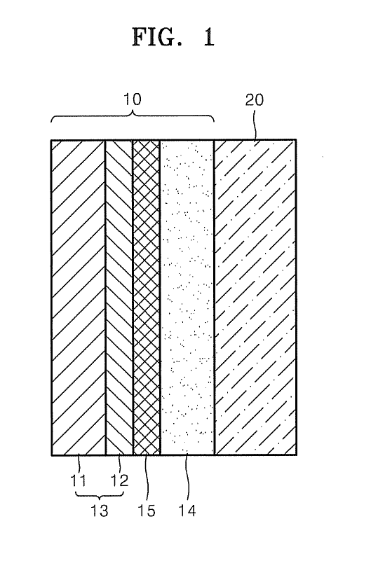

FIG. 1 is a schematic cross-sectional view of an electrode 10 for a fuel cell according to an embodiment of the present invention. Referring to FIG. 1, a diffusion layer 13 may include a support 11 and a microporous layer 12, a catalyst layer 14 may be disposed facing the microporous layer 12 of the diffusion layer 13, and a barrier layer 15 is disposed between the microporous layer 12 and the catalyst layer 14. These layers may be disposed adjacent to each other, and other functional layers may be further disposed among the layers. An electrolyte membrane 20 may be disposed adjacent to the catalyst layer 14.

The diffusion layer 13 includes the support 11 and the microporous layer 12 and the diffusion layer 13 may have an electron conducting property for delivering a current generated in the catalyst layer 14. Also, the diffusion layer 13 may be porous to quickly discharge water generated in the catalyst layer 14 and to allow air to smoothly flow therethrough.

The support 11 may be an electrically conductive material, such as a metallic or carbonaceous material. For example, the support 11 may be a conductive substrate formed of carbon paper, carbon cloth, carbon felt, or metal cloth, but is not limited thereto.

The microporous layer 12 may include a conductive powder having a relatively small particle size, for example, carbon powder, carbon black, acetylene black, activated carbon, carbon fiber, fullerene, carbon nano-tube, carbon nano-wire, carbon nano-horn, or carbon nano-ring. Regarding the conductive powder that forms the microporous layer, if the particle size is too small, the pressure of gas increases too much, and thus, gas diffusion may not occur sufficiently, and if the particle size is too great, obtaining uniform gas diffusion may be difficult. Accordingly, in consideration of the gas diffusion effect, typically, the particle size of the conductive powder may be in a range of about 10 nm to about 50 nm. A commercially available product may be used for the diffusion layer 13. Alternatively, only carbon paper is purchased and then the microporous layer 12 is directly coated thereon for use as the diffusion layer 13. In the microporous layer 12, gas diffuses through pores formed among the conductive powder particles and the average pore size of the pores is not limited. For example, the average pore size of the microporous layer 12 may be in the range of about 1 nm to about 10 μm. For example, the average pore size of the microporous layer 12 may be in the range of about 5 nm to about 1 μm, the range of about 10 nm to about 500 nm, or the range of about 50 nm to about 400 nm.

The thickness of the diffusion layer 13 may be in the range of about 200 μm to about 400 μm in consideration of the gas diffusion effect and electric resistance. For example, the thickness of the diffusion layer 13 may be in therange of about 100 μm to about 350 μm, or in the range of about 200 μm to about 350 μm.

The catalyst layer 14 includes metallic catalyst particles, and any of various materials typically used in the art may be available for the catalyst layer 14. Examples of the metallic catalyst particles are platinum (Pt), ruthenium (Ru), tin (Sn), palladium (Pd), titanium (Ti), vanadium (V), chromium (Cr), manganese (Mn), iron (Fe), cobalt (Co), nickel (Ni), copper (Cu), zinc (Zn), aluminum (Al), molybdenum (Mo), selenium (Se), tungsten (W), iridium (Ir), osmium (Os), rhodium (Rh), niobium (Nb), tantalium (Ta), lead (Pb), a mixture thereof, or an alloy thereof. The average particle size of the metallic catalyst particles may be in the range of, for example, about 2 nm to about 10 nm. The metallic catalyst particles described above may be supported by a carbon support for use as a catalyst layer, and the average diameter of the carbon support may be in the range of about 20 nm to about 50 nm. The cathode catalyst layer may be, for example, a Pt alloy catalyst, such as Pt/C, PtCo/C, or PtCr/C, and the anode catalyst layer may be an alloy catalyst, such as Pt/C or PtRu/C.

The catalyst layer 14 may have pores among the carbon support particles supporting the metallic catalyst particles, and when the carbon support particles agglomerate to form secondary particles, pores may be further formed among the secondary particles. The average pore size of the pores may be in the range of about 1 nm to about 1 μm. For example, the average pore size of the catalyst layer 14 may be in therange of about 10 nm to about 700 nm, about 50 nm to about 500 nm, or about 70 nm to about 200 nm

The thickness of the catalyst layer 14 may be controlled to be in therange of about 10 μm to about 100 μm to effectively activate an electrode reaction and to prevent an excessive increase in the electric resistance. For example, the thickness of the catalyst layer 14 may be in therange of about 20 μm to about 60 μm, or in therange of about 30 μm to about 50 μm.

The catalyst layer 14 may further include a binder resin for enhancing the adhesive force of the catalyst layer and for delivering hydrogen ions.

The binder resin may be a polymer resin that conducts hydrogen ions, for example, a polymer resin having, in a side chain, a cation exchanger selected from the group consisting of a sulfonic acid group, a carboxylic acid group, a phosphoric acid group, a phosphonic acid group, and a derivative thereof. For example, the binder may include one or more hydrogen ion conducting polymers selected from the group consisting of a fluoro-based polymer, a benzimidazole-based polymer, a polyimide-based polymer, a polyetherimide-based polymer, a polyphenylenesulfide-based polymer, a polysulfone-based polymer, a polyethersulfone-based polymer, a polyetherketone-based polymer, a polyether-etherketone-based polymer, and a polyphenylquinoxaline-based polymer.

The barrier layer 15 is interposed between the microporous layer 12 of the diffusion layer 13 and the catalyst layer 14. The barrier layer 15 may be formed of a porous matrix having an average pore size that is greater than those of the catalyst layer 14 and the microporous layer 12. When the phosphoric acid arrives at the barrier layer 15 through the pores of the catalyst layer 14, due to the greater average pore size of the barrier layer 15 than that of the catalyst layer 14, the capillary force is suddenly decreased, and thus, the phosphoric acid may not pass through the pores of the barrier layer 15. Even when the phosphoric acid passes through the pores of the barrier layer 15, the flow rate of phosphoric acid is substantially decreased. That is, due to the capillary phenomenon of the barrier layer 15, the flow of phosphoric acid from the catalyst layer 14 to the diffusion layer 13 may be controllable.

As described above, the average pore size of the barrier layer 15 may be greater than the average pore sizes of the catalyst layer 14 and the microporous layer 12 or the average pore size of at least the catalyst layer 14, and may not be particularly limited. That is, once the catalyst layer 14 and the microporous layer 12 and their average pore sizes are selected, a porous matrix material having an average pore size that is greater than their average pore sizes is used to form the barrier layer 15. The average pore size of the barrier layer 15 may be greater than the average pore size of the catalyst layer 14 and the average pore size of the microporous layer 12 and, for example, 25 μm or less. For example, the average pore size of the barrier layer 15 may be greater than the average pore size of the catalyst layer 14 and the average pore size of the microporous layer 12 and the average pore size of the barrier layer 15 may be 10 μm or less, 5 μm or less, or 1 μm or less.

Also, the maximum size of the pores of the barrier layer 15 may be 50 μm or less. If the maximum size of the pores of the barrier layer 15 is greater than 50 μm, the suppression of the phosphoric acid leakage due to the capillary phenomenon may be surpassed by phosphoric acid leakage due to diffusion. The maximum size of the pores of the barrier layer 15 may be, for example, 30 μm or less or 25 μm or less.

Also, the minimum size of the pores of the barrier layer 15 may be 1 nm or more. If the minimum size of the pores is smaller than 1 nm, water or fuel gas may not be easily discharged at a high temperature. The minimum size of the barrier layer 15 may be, for example, in a range of 3 nm or more, 5 nm or more, 10 nm or more, or 20 nm or more.

The pores of the barrier layer 15 may be connected to each other in the thickness direction thereof to form a passage through which gas passes between the catalyst layer 14 and the microporous layer 12 of the diffusion layer 13. The passage formed by the pores may suppress the flow of phosphoric acid while discharging water or gas, such as a fuel gas.

As such, the barrier layer 15 has a pore size that is appropriate to block the leakage of phosphoric acid to the diffusion layer 13, and a material for forming the barrier layer 15 may not be limited to the porous matrix materials described above.

Also, the barrier layer 15 has a conductive property to allow electrons generated in the catalyst layer 14 to pass through the diffusion layer 13 of the electrode 10 and an anti-corrosive property to prevent oxidation at a high voltage. Also, the material for forming the barrier layer 15 may not dissolve in phosphoric acid. As long as such characteristics are satisfied, any material may be available for forming the barrier layer 15. For example, the barrier layer 15 may include at least one conductive material selected from the group consisting of a carbonaceous material, a metallic material, a polymeric material, and a ceramic material.

Examples of a carbonaceous material may include at least one material selected from the group consisting of carbon powder, carbon black, acetylene black, activated carbon, carbon fiber, fullerene, carbon nano-tube, carbon nano-wire, carbon nano-horn, and carbon nano-ring.

Examples of a metallic material include gold (Au), silver (Ag), platinum (Pt), palladium (Pd), copper (Cu), rhodium (Rh), ruthenium (Ru), iridium (Ir), osmium (Os), rhenium (Re), and the like.

A polymer material may include a π-conjugated polymeric material having a chain structure in which a single bond and a double bond of carbon atoms are alternately arranged, and thus, π-electrons move freely to a certain level, thereby generating electric conductivity. Examples of the π-conjugated polymeric material are polyacetylenes, polyanilines, polypyrroles, polythiophenes, poly sulfur nitrides, poly para-phenylenes, and the like.

A ceramic material may include a compound including at least one of transition metals of Groups 3 to 8 in the Periodic Table including lanthanide metals. Examples of the compound include an oxide, carbonate, nitride, or borate including at least one of the transition metal and the lanthanide metal, and may further include compounds having electro-conductivity without any other limitations. Examples of the compound are indium tin oxide, (ITO), fluorine doped tin oxide (FTO), molybdenum doped indium oxide, aluminum doped zinc oxide, and other metallic compounds including, for example, titanium (Ti) as the metal. To form the barrier layer 15, these materials may be used individually, in a mixture or composite of two or more thereof, or in a plurality of porous matrices stacked on each other to form a multi-layered structure. If the barrier layer 15 has a multi-layered structure, different materials may be used to form the respective porous matrices, or the respective porous matrices may be formed to have different average pore sizes.

The barrier layer 15 may be a porous matrix formed of a particulate matter. Especially when the catalyst layer 14 and the microporous layer 12 are formed of a particulate matter, the average pore size of the respective layers may be easily controlled in consideration of particle sizes of the respective layers. Accordingly, a capillary phenomenon may be easily controlled to reduce the leakage of phosphoric acid.

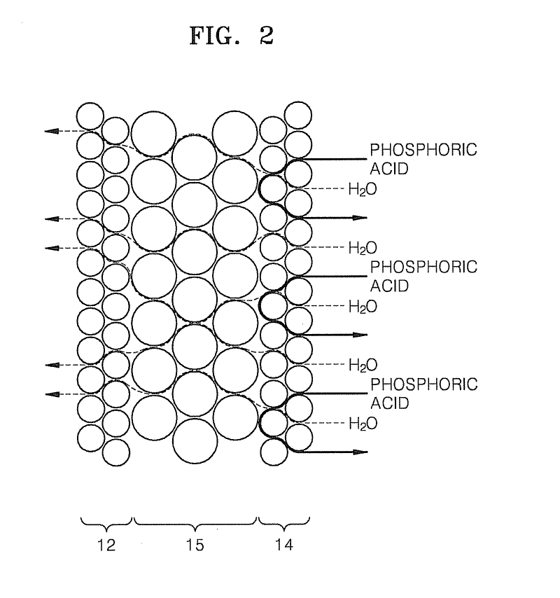

FIG. 2 is an enlarged cross-sectional view of the electrode 10 of FIG. 1, illustrating how leakage of phosphoric acid is suppressed toward the diffusion layer 13. As illustrated in FIG. 2, the barrier layer 15 may include particles having a greater size than those of the microporous layer 13 and the catalyst layer 14 and pores may be formed among the particles. The pores form a passage through which gas passes between the microporous layer 13 and the catalyst layer 14. A fuel gas or water generated in the catalyst layer 14, for example, a vapor generated in a high-temperature polymer electrolyte membrane fuel cell (PEMFC), may pass through the pores formed among the particles to the microporous layer 12. However, in the case of phosphoric acid, even when phosphoric acid passes through the catalyst layer 14 due to a capillary phenomenon, due to a sudden decrease in the capillary force of the barrier layer 15 having larger sizes, the leakage of phosphoric acid is suppressed.

The average size of the particles of the barrier layer 15 may be greater than those of particles of the microporous layer 13 and the catalyst layer 14, and may be 50 μm or less. The average particle size of the barrier layer 15 may be, for example, in the range of about 100 nm to about 50 μm, or the range of about 1 μm to about 10 μm.

A material for forming the particles of the barrier layer 15 may not be limited to the above described materials, and the carbonaceous material, the metallic material, the polymeric material, the ceramic material, and the like described above may also be used in forming the particles of the barrier layer 15. For example, the particles of the barrier layer 15 may include a carbonaceous material, and for example, the carbonaceous material may include at least one carbonaceous material selected from the group consisting of carbon powder, carbon black, acetylene black, activated carbon, carbon fiber, fullerene, carbon nano-tube, carbon nano-wire, carbon nano-horn, and carbon nano-ring.

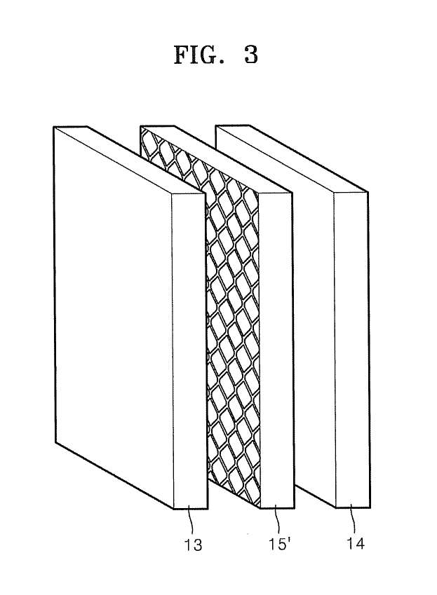

According to another embodiment of the present invention, the porous matrix may include, instead of the carbonaceous material, at least one metallic porous structure selected from the group consisting of metal mesh or metal foam. For example, FIG. 3 illustrates a barrier layer 15′ formed of a metal mesh disposed between the microporous layer 13 and the catalyst layer 14. The capillary phenomenon is controlled using pores of the metal mesh, and thus, the leakage of phosphoric acid may be reduced. In this regard, the shape of the metal mesh may be variously changed, and is not limited to the shape illustrated in FIG. 3.

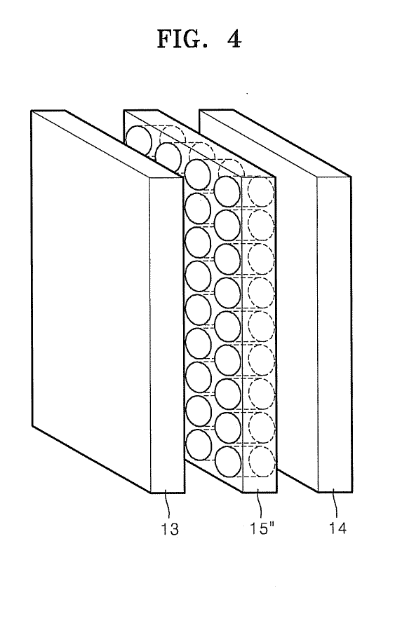

According to another embodiment of the present invention, the barrier layer 15 may include a porous matrix having a plurality of pores that are spaced at predetermined intervals and extend in the thickness direction thereof. FIG. 4 illustrates a barrier layer 15″ interposed between the microporous layer 13 and the catalyst layer 14, and the barrier layer 15″ has a plurality of pores extending in a thickness direction thereof and by controlling sizes of the pores, the capillary phenomenon is controlled to reduce the leakage of phosphoric acid. In this case, regarding the barrier layer 15″, the shape and arrangement of the pores may be variously changed and may not be limited to those illustrated in FIG. 4.

Hereinbefore, the shapes of the porous matrix have been described above. However, those are just examples and it may be known to one of ordinary skill in the art that the above embodiments may have different forms and should not be construed as being limited to the descriptions described above.

Also, according to an embodiment of the present invention, the barrier layer 15 may further include a water repellent material at the surface of the porous matrix. The water repellent material may be coated on the surface of the porous matrix other than the pores to supply a water repellent property to the structure surrounding each of the pores. In this case, the pores may not be clogged by the phosphoric acid, and thus, gas may be more efficiently allowed to pass therethrough. Due to the water repellent treatment for the barrier layer 15, for example, when a barrier layer is formed of a particulate matter, the contact resistance between adjacent particles may be increased, but the diffusion overcharge caused by gas diffusion may be much greater than the overcharge caused by contact between particles. Accordingly, the water repellent treatment may overall contribute to higher performance of the fuel cell.

Examples of the water repellent material may be a polymer selected from the group consisting of polytetrafluoroethylene (PTFE), fluorinated ethylene propylene (FEP), polyvinylidenefluoride (PVdF), perfluoroalkoxy (PFA), a 2,2-bistrifluoromethyl-4,5-difluoro-1,3-dioxole tetrafluoroethylene copolymer, and a sulfonated tetrafluoroethylene-based fluoropolymer-copolymer. For example, a sulfonated tetrafluoroethylene-based fluoropolymer-copolymer, such as Fluorosarf (product name) manufactured by (China) Fluoro Technology Co., Ltd., CYTOP® (product name) manufactured by Asahi Glass Co., Ltd., or NAFION® (product name) manufactured by DuPont Corp., may be commercially available for use as the water repellent material. These water repellent materials may be used alone or in combination of two or more. The water repellent material may be simply mixed with the material that forms the porous matrix, or may be coated on the material that forms the porous matrix in advance and then a barrier layer is formed.

According to an embodiment of the present invention, the barrier layer 15 may further include a catalytic metal supported on the porous matrix of the barrier layer 15. When the barrier layer 15 includes a porous matrix formed of a carbonaceous material, the catalytic metal may be supported on the carbonaceous porous matrix. As the supported catalytic metal, a material selected from the group consisting of platinum (Pt), iron (Fe), cobalt (Co), nickel (Ni), ruthenium (Ru), rhodium (Rh), palladium (Pd), osmium (Os), iridium (Ir), copper (Cu), silver (Ag), gold (Au), tin (Sn), titanium (Ti), chromium (Cr), a mixture thereof, and an alloy thereof may be used. The catalytic metal-supported barrier layer 15 may prevent the leakage of phosphoric acid, and like the catalyst layer 14, may activate an electrode reaction at an anode or a cathode.

As described above, the barrier layer 15 may include a porous matrix as a single layer, or may have a multi-layered structure formed by stacking two or more porous matrices. In this regard, the respective porous matrices of the multi-layered structure may have different pore sizes.

The thickness of the barrier layer 15 may be in the range of about 10 μm to about 50 μm. If the barrier layer 15 is too thick, the electric resistance thereof may increase, and if the barrier layer 15 is too thin, it is difficult to control the capillary phenomenon and thus, decreasing the flow of phosphoric acid is difficult. Accordingly, if the barrier layer 15 is formed to have the above thickness range, the leakage of phosphoric acid may be reduced without an excessive increase in electrical resistance.

A membrane electrode assembly for a fuel cell, according to an embodiment of the present invention, includes a cathode; an anode facing the cathode; and a polymer electrolyte membrane disposed between the cathode and the anode, wherein at least one of the cathode and the anode includes the electrode structure described above.

According to an embodiment of the present invention, either of the cathode or the anode of the membrane electrode assembly has the electrode structure described above. If at least the cathode has the electrode structure described above, the leakage of phosphoric acid due to the discharge of water generated at the cathode may be preventable. Also, if both of the cathode and the anode have the electrode structure described above, the leakage of phosphoric acid that may occur in the membrane electrode assembly may be preventable as much as possible.

The polymer electrolyte membrane may not be particularly limited and may include at least one material selected from the group consisting of polybenzimidazole (PBI), cross-linked polybenzimidazole, poly 2,5-benzimidazole (ABPBI), polyurethane, and modified polytetrafluoroethylene (PTFE).

The polymer electrolyte membrane may be impregnated with a phosphoric acid or an organic phosphoric acid, and other acids may also be used instead of the phosphoric acid. The concentration of the phosphoric acid is not limited and may be in the range of about 80 to about 100 wt %, and for example, 85 wt % of phosphoric acid aqueous solution may be used.

A fuel cell according to an embodiment of the present invention includes the membrane electrode assembly described above. The membrane electrode assembly and the fuel cell may be manufactured by using methods disclosed in various references. Thus, a description of the methods will not be presented herein.

One or more embodiments will now be described in further detail with reference to the following examples. These examples are for illustrative purpose only and are not intended to limit the scope of the one or more embodiments.

### Comparative Example 1 (Support/MPL/Electrolyte Membrane/MPL/Support)

In order to compare how much a phosphoric acid leaks due to the formation of a barrier layer, a diffusion layer was formed by coating KETJENBLACK® (Akzo Nobel Chemicals B.V.) having a thickness of about 40 μm as a microporous layer (MPL) on a carbon paper having a thickness of 280 μm, and then, a phosphoric acid-impregnated polybenzoxazine polymer electrolyte membrane was placed between two of the diffusion layers without insertion of a catalyst layer, thereby completing assembling of a unit cell for a fuel cell.

### Example 1 (Support/MPL/Barrier Layer/Electrolyte Membrane/Barrier Layer/MPL/Support)

A barrier layer that included 97 wt % of carbon powder having a particle size of about 1 to about 2 μm and 3 wt % of a PVdF binder was coated on a diffusion layer in which KETJENBLACK having a thickness of about 40 μm was coated as a microporous layer (MPL) on a carbon paper having a thickness of 280 μm, and then dried at a temperature of 80° C. for 1 hour. A phosphoric acid-impregnated polybenzoxazine polymer electrolyte membrane was interposed between two of the diffusion layers each coated with the barrier layer, thereby completing assembling of a unit cell for a fuel cell.

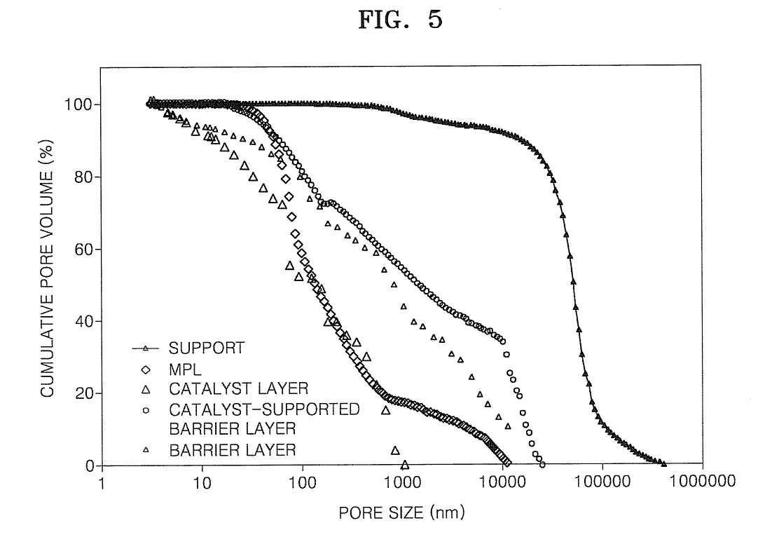

Pore distributions of the supports, the MPLs, and the barrier layers were measured using a Mercury Porosimeter and a cumulative curve of pore distribution was drawn from greater pore sizes to smaller pore sizes. The cumulative pore volume distribution is illustrated in FIG. 5. As illustrated in FIG. 5, regarding the average pore size at a point where the cumulative frequency is 50%, the average pore size of the barrier layer is greater than the average pore size of the MPL.

### Evaluation Example 1: Phosphoric Acid Leakage Amount with Respect to Barrier Layer

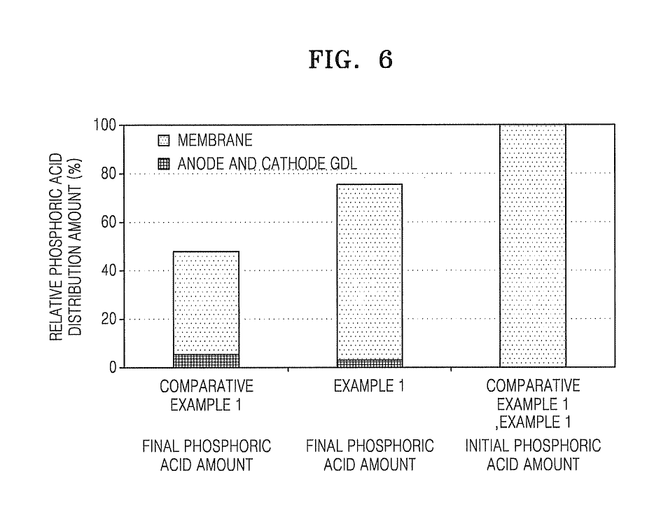

The unit cells manufactured according to Comparative Example 1 and Example 1 were preserved at a temperature of 80° C. for 3 weeks, and then, in each of the unit cells, electrodes having the diffusion layers (i.e. gas diffusion layers) were separated from the polymer electrolyte membrane and the electrodes and the polymer electrolyte membranes were diluted with water and an amount of the remaining phosphoric acid therein was measured by adjustment with a 0.1 M NaOH solution. Bar graphs showing relative distribution results are shown in FIG. 6.

As illustrated in FIG. 6, it was confirmed that in the case of the unit cell manufactured according to Comparative Example 1 in which a barrier layer was Oct included, 50% or more of the initial amount of phosphoric acid impregnated in the electrolyte membrane leaked and about 5% flowed into the diffusion layer. On the other hand, in the case of the unit cell manufactured according to Example 1 in which a barrier layer was inserted between a microporous layer and an electrolyte membrane, about 24% of the initial amount of phosphoric acid impregnated in the electrolyte membrane leaked and the amount of phosphoric acid flowing into the diffusion layer was reduced.

### Comparative Example 2 (Support/MPL/Cathode Catalyst Layer/Electrolyte Membrane/Anode Catalyst Layer/MPL/Support)

A catalyst slurry including 0.5 g of Pt/C, 2 g of NMP, and 0.25 g of a polybenzoxazine (PBOA) binder solution (5% in H₂O) was coated on a diffusion layer in which KETJENBLACK having a thickness of about 40 μm was coated as a microporous layer (MPL) on a carbon paper having a thickness of 280 μm, and then dried in an oven at a temperature of 80° C. for 1 hour, at a temperature of 120° C. for 30 minutes, and at a temperature of 150° C. for 10 minutes, thereby forming a cathode and an anode. Then, a phosphoric acid-impregnated polybenzoxazine polymer membrane was placed between the cathode and the anode and assembled, thereby preparing a membrane-electrode assembly (MEA). Then, the MEA was used to manufacture a fuel cell.

### Example 2 (Support/MPL/Barrier Layer/Cathode Catalyst Layer/Electrolyte Membrane/Anode Catalyst Layer/MPL/Support)

A barrier layer that included 97 wt % of carbon powder having a particle size of about 1 to about 2 μm and 3 wt % of a PVdF binder was coated on a diffusion layer in which KETJENBLACK having a thickness of about 40 μm was coated as a microporous layer (MPL) on a carbon paper having a thickness of 280 μm, and then dried at a temperature of 80° C. for 1 hour.

Also, a catalyst slurry including 0.5 g of Pt/C, 2 g of NMP, and 0.25 g of PBOA binder solution (5% in H₂O) was coated on a phosphoric acid-impregnated polybenzoxazine polymer film and dried in an oven at a temperature of 60° C. for 10 minutes to prepare a cathode.

Separately, a catalyst slurry including 0.5 g of Pt/C, 2 g of NMP, and 0.25 g of PBOA binder solution (5% in H₂O) was coated on a diffusion layer in which KETJENBLACK having a thickness of about 40 μm was coated as a microporous layer (MPL) on a carbon paper having a thickness of 280 μm and dried in an oven at a temperature of 80° C. for 1 hour, at a temperature of 120° C. for 30 minutes, and at a temperature of 150° C. for 10 minutes to prepare an anode.

The barrier layer coated on the diffusion layer, the polymer film on which the cathode was coated, and the anode coated on the diffusion layer were assembled to form an MEA in which the barrier layer was formed at only the cathode, and then the MEA was used to manufacture a fuel cell.

### Example 3 (Support/MPL/Barrier Layer Subjected to Repellent Treatment/Cathode Catalyst Layer/Electrolyte Membrane/Anode Catalyst Layer/MPL/Support)

A fuel cell was manufactured in the same manner as in Example 2, except that a barrier layer including 80 wt % of of carbon powder having a particle size of about 1 to about 2 μm and 20 wt % of of NAFION binder was used. In Example 3, the NAFION binder that has a stronger repellent property than a PVdF binder was used in relatively high amount, thereby providing a repellent property to the barrier layer.

### Example 4 (Support/MPL/Catalytic Metal-Carrying Barrier Layer/Cathode Catalyst Layer/Electrolyte Membrane/Anode Catalyst Layer/MPL/Support

A catalyst slurry including 0.5 g of Pt/C, 2 g of NMP, and 0.25 g of PBOA binder solution (5% in H₂O) was coated on a diffusion layer in which KETJENBLACK having a thickness of about 40 μm was coated as a microporous layer (MPL) on a carbon paper having a thickness of 280 μm, and than dried in an oven at a temperature of 80° C. for 1 hour, at a temperature of 120° for 30 minutes, and at a temperature of 150° C. for 10 minutes to prepare a barrier layer having first pores.

Also, a catalyst slurry including 0.5 g of Pt/C, 2 g of H₂O, and 0.25 g of PBOA binder solution (5% in H₂O) was coated on a phosphoric acid-impregnated polybenzoxazine polymer film and dried in an oven at a temperature of 60° C. for 10 minutes to prepare a cathode having second pores. In this case, the Pt/C particles of the barrier layer and the cathode were selected in such a way that the first pores were larger than the second pores.

Separately, a catalyst slurry including 0.5 g of Pt/C, 2 g of NMP, and 0.25 g of PBOA binder solution (5% in H₂O) was coated on a diffusion layer in which KETJENBLACK having a thickness of about 40 μm was coated as a microporous layer (MPL) on carbon paper having a thickness of 280 μm and dried in an oven at a temperature of 80° C. for 1 hour, at a temperature of 120° C. for 30 minutes, at a temperature of 150° C. for 10 minutes to prepare an anode.

The barrier layer coated on the diffusion layer, the polymer film on which the cathode was coated, and the anode coated on the diffusion layer were assembled to form an MEA in which the barrier layer with the supported catalyst metal was formed only at the cathode, and then the MEA was used to manufacture a fuel cell.

The manufacturing conditions for the supports, the MPLs, and the barrier layers used in the fuel cells manufactured according to Examples 2 to 4 and Comparative Example 2 are the same as those described with reference to Example 1 and Comparative Example 1. Cumulative pore volume distribution results of the supports, the MPLs, the barrier layers, the catalytic metal-supporting barrier layers, and the cathode/anode catalyst layers used in the fuel cells manufactured according to Examples 2 to 4 and Comparative Example 2 are illustrated in FIG. 5. As illustrated in FIG. 5, it is confirmed that the average pore size of the barrier layer is greater than those of the MPL and the barrier layer.

### Evaluation Example 2: Voltage Evaluation with Respect to DSS Operation

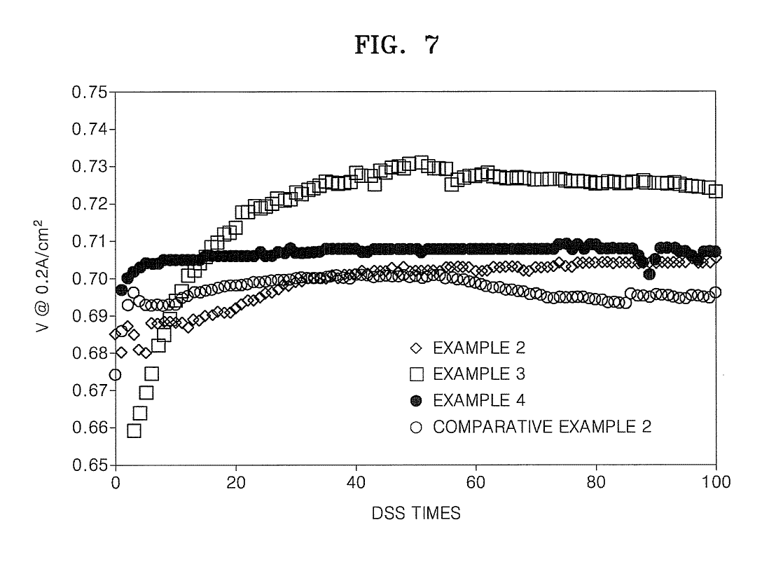

The fuel cells manufactured according to Comparative Example 2 and Examples 2 to 4 were operated at a temperature of 150° C. while about 250 ccm of air was supplied to the corresponding cathodes and 100 ccm of hydrogen was supplied to the corresponding anodes. After two hours of operation, the current flow was stopped, and the fuel supply and the battery heating were stopped too. When the fuel cells were cooled to 40° C. or less, the battery heating was started, and when the fuel cells were heated to a temperature of 150° C., the fuel supply was started, and at a current of 0.2 A/cm², the operation was started. After two hours of operation, the operation of the fuel cells was stopped and such a stop-start operation was repeatedly performed. A voltage according to 100 times of the daily stop start (DSS) operation was measured, and measuring results thereof are shown in FIG. 7.

As shown in FIG. 7, when the DSS operation was performed 100 times, the fuel cells manufactured according to Examples 2 to 4 show a substantially smaller voltage decrease than the fuel cell manufactured according to Comparative Example 2.

### Evaluation Example 3: Measurement of Phosphoric Acid Amount after DSS Operation

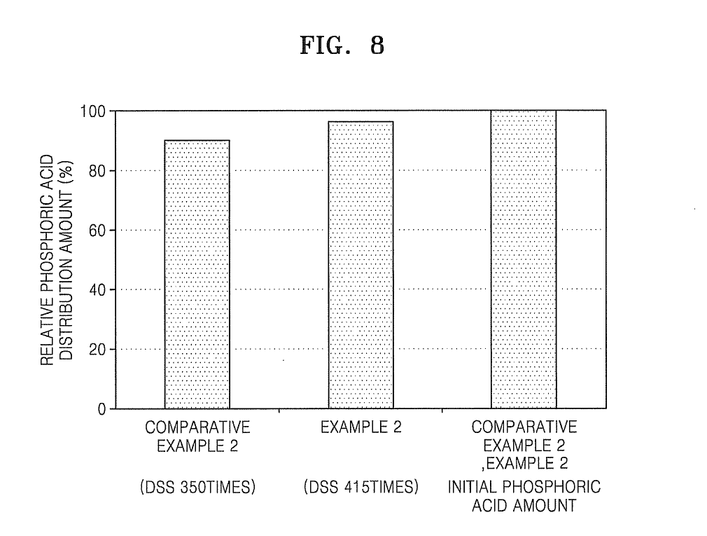

The DSS operation was performed on the fuel cells manufactured according to Comparative Example 2 and Example 2 under the conditions used in Evaluation Example 2, and the relative amount of phosphoric acid remaining in the MEA is illustrated in FIG. 8.

As illustrated in FIG. 8, it was confirmed that in the case of the fuel cell manufactured according to Comparative Example 2, after 350 times of the DSS operation, the initial amount of the phosphoric acid impregnating the MEA was reduced by about 11%. On the other hand, in the case of the fuel cell manufactured according to Example 1, after 415 times of the DSS operation, the initial amount of the phosphoric acid was reduced by as little as 5%. From the results described above, it was confirmed that the fuel cell of Example 2 shows a substantially smaller amount of phosphoric acid leakage and improved lifetime characteristics of the MEA, due to the inclusion of the barrier layer between the catalyst layer and the diffusion layer.

As described above, according to the one or more of the above embodiments of the present invention, due to the inclusion of a barrier layer between a catalyst layer and a diffusion layer in which an average pore size of the barrier layer is greater than those of the catalyst layer and the diffusion layer, an electrode for a fuel cell may reduce leakage of phosphoric acid flowing from the catalyst layer to the diffusion layer and improve lifetime characteristics of a membrane electrode assembly.

It should be understood that the exemplary embodiments described therein should be considered in a descriptive sense only and not for purposes of limitation. Descriptions of features or aspects within each embodiment should typically be considered as available for other similar features or aspects in other embodiments.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An electrode for a fuel cell, the electrode comprising:
a diffusion layer comprising a support and a microporous layer disposed on the support;
a catalyst layer disposed facing the microporous layer; and
a barrier layer disposed between the catalyst layer and the microporous layer,
wherein the average pore size of the barrier layer is greater than the average pore size of the catalyst layer and the average pore size of the microporous layer

2. The electrode of claim 1, wherein the maximum size of pores of the barrier layer is 50 μm or less.

3. The electrode of claim 1, wherein the minimum size of pores of the barrier layer is 1 nm or more.

4. The electrode of claim 1, wherein the average pore size of the barrier layer is 25 μm or less.

5. The electrode of claim 1, wherein the average pore size of the barrier layer is 10 μm or less.

6. The electrode of claim 1, wherein the average pore size of the barrier layer is in a range of about 200 nm to about 5 μm.

7. The electrode of claim 1, wherein the barrier layer comprises at least one conductive material selected from the group consisting of a carbonaceous material, a metallic material, a polymeric material, and a ceramic material.

8. The electrode of claim 7, wherein the carbonaceous material comprises at least one material selected from the group consisting of carbon powder, carbon black, acetylene black, activated carbon, carbon fiber, fullerene, carbon nano-tube, carbon nano-wire, carbon nano-horn, and carbon nano-ring.

9. The electrode of claim 1, wherein the barrier layer further comprises a particulate matter.

10. The electrode of claim 9, wherein the diameter of the particulate matter is in the range of about 0.1 to about 50 μm.

11. The electrode of claim 1, wherein the barrier layer further comprises at least one metal porous structure selected from the group consisting of metal mesh and metal foam.

12. The electrode of claim 1, wherein the barrier layer further comprises a water repellent material.

13. The electrode of claim 12, wherein the water repellent material comprises at least one polymer selected from the group consisting of polytetrafluoroethylene (PTFE), fluorinated ethylene propylene (FEP), polyvinylidenefluoride (PVdF), perfluoroalkoxy (PFA), a 2,2-bistrifluoromethyl-4,5-difluoro-1,3-dioxole tetrafluoroethylene copolymer, and a sulfonated tetrafluoroethylene-based fluoropolymer-copolymer.

14. The electrode of claim 1, wherein a catalytic metal is supported on the barrier layer.

15. The electrode of claim 14, wherein the catalytic metal is selected from the group consisting of platinum (Pt), iron (Fe), cobalt (Co), nickel (Ni), ruthenium (Ru), rhodium (Rh), palladium (Pd), osmium (Os), iridium (Ir), copper (Cu), silver (Ag), gold (Au), tin (Sn), titanium (Ti), chromium (Cr), a mixture thereof, and an alloy thereof.

16. The electrode of claim 1, wherein the barrier layer has a multi-layered structure in which a plurality of porous matrices are stacked.

17. The electrode of claim 16, wherein the stacked porous matrices have different average pore sizes.

18. The electrode of claim 1, wherein the thickness of the barrier layer is in a range of about 5 to about 50 μm.

19. The electrode of claim 1, wherein the barrier layer suppresses leakage of an inorganic acid or an organic acid from the catalyst layer to the diffusion layer.

20. A membrane electrode assembly for a fuel cell, the membrane electrode assembly comprising:
a cathode;
an anode facing the cathode; and
a polymer electrolyte membrane disposed between the cathode and the anode, wherein at least one of the cathode and the anode comprises the electrode of claim 1.

21. A fuel cell comprising the membrane electrode assembly of claim 20.
